(19) United States
(12) Patent Application Publication
(10) Pub. No.: US 2014/0355304 A1
(43) Pub. Date: Dec. 4, 2014

(54) LIGHT SOURCE MODULE, AND LIQUID CRYSTAL DISPLAY DEVICE

(71) Applicant: Sharp Kabushiki Kaisha, Osaka-shi, Osaka (JP)

(72) Inventors: Kazuya Ikuta, Osaka-shi (JP); Shota Inoue, Osaka-shi (JP)

(73) Assignee: Sharp Kabushiki Kaisha, Osaka-shi, Osaka (JP)

(21) Appl. No.: 14/369,758

(22) PCT Filed: Dec. 13, 2012
(86) PCT No.: PCT/JP2012/082282

§ 371 Date: Jun. 30, 2014

(30) Foreign Application Priority Data
Feb. 23, 2012 (JP) 2012-037783

(51) Int. Cl. F21V 8/00

(52) U.S. Cl. CPC G02B 6/0031
USPC 362/611

(57) ABSTRACT

A light source module with which light leakage can be efficiently reduced and an increase in costs can be suppressed.

A backlight module 10 according to an embodiment of the present invention includes an optical waveguide 130 which receives light emitted from an LED group 104 at an incident surface 131 and emits the light from an emission surface 133; and a P-chassis 180 that presses the optical waveguide 130 from an emission-surface-133 side and that is arranged so as to cover a portion of the emission surface 133 near the incident surface 131. A center position of a light emitting surface of the LED group 104 is located closer to the emission surface 133 than a centerline of the incident surface 131.

### TECHNICAL FIELD

The present invention relates to a light source module and a liquid crystal display device including the light source module.

### BACKGROUND ART

In liquid crystal display devices including liquid crystal displays (LCD) according to the related art, backlights having side-edge-type (also referred to as side-light-type) optical waveguides, which receive light from light sources and emit the light in planar form, are often used to achieve reduction in thickness.

In such a side-edge-type optical waveguide, light sources, such as LEDs, are arranged so as to face respective end surfaces (hereinafter referred to as incident end surfaces) of the optical waveguide. Light is incident on each incident end surface of the optical waveguide. The incident light propagates through the optical waveguide while being reflected, and is emitted from a light emission surface of the optical waveguide.

In recent years, with the reduction in thickness of liquid crystal display devices, the thickness of the optical waveguide has been reduced. Accordingly, the size of the light sources relative to that of the incident end surfaces of the optical waveguide has been increased. Therefore, lost light, which is light that is not incident on the optical waveguide and does not propagate through the optical waveguide, is easily generated. When the lost light serves as stray light and is emitted from an unintended portion of the optical waveguide, light leakage occurs. This is one of the causes of nonuniform brightness of the liquid crystal display.

This problem occurs because, since the size of the light sources is equivalent to the thickness of the optical waveguide, the distance between the top edge of the optical waveguide and the top edge of each light source in the thickness direction of the optical waveguide and the distance between the bottom edge of the optical waveguide and the bottom edge of each light source in the thickness direction of the optical waveguide are reduced.

In the case where the size of the light sources is sufficiently small relative to the thickness of the optical waveguide and the center of each light source is at the center of the optical waveguide in the thickness direction, almost all of the light from each light source is incident on the corresponding incident end surface of the optical waveguide in a central region thereof, and the amount of light incident on the incident end surface at the top and bottom edges of the optical waveguide is small. In the case where the size of the light sources is equivalent to the thickness of the optical waveguide, even when the center of each light source is at the center of the optical waveguide in the thickness direction, an amount of light emitted from the top edge of each light source toward the top edge of the corresponding incident end surface of the optical waveguide and from the bottom edge increases. Also, an amount of light that is not incident on the optical waveguide and leaks to the outside increases.

As a technology for reducing the light leakage, PTL 1, for example, describes a configuration in which a light shielding member provided on a light emission side of an optical waveguide includes an extended portion.

In addition, PTL 2 discloses a technology in which a double-sided adhesive member used to bond a reflective sheet provided on an optical waveguide at a side opposite to a light emission side to a light shielding frame that supports the optical waveguide is made of a non-transparent light shielding material.

### CITATION LIST

### Patent Literature

PTL 1: Japanese Unexamined Patent Application Publication No. 2010-164916 (published Jul. 29, 2010)

PTL 2: Japanese Unexamined Patent Application Publication No. 2009-301912 (published Dec. 24, 2009)

### SUMMARY OF INVENTION

### Technical Problem

With the technology described in PTL 1, light leakage from the top surface of the optical waveguide can be prevented. However, the number of components is increased to prevent the light leakage, and the cost is increased accordingly.

In general, to maximize the utilization ratio of light emitted from a light source, a reflective sheet is preferably arranged on the bottom surface of an optical waveguide so as to extend to a position close to the light source. The optical waveguide and the reflective sheet are easily affected by heat emitted from the light source in a region near the light source, and expand due to the heat from the light source. Therefore, in the case where the optical waveguide and the reflective sheet have different coefficients of expansion, if the optical waveguide and the reflective sheet are fixed to each other without leaving a gap therebetween, stress is generated when they expand and there is a possibility that separation or distortion will occur in the fixed section. For this reason, the optical waveguide and the reflective sheet are preferably not fixed to each other, and a gap is preferably provided between the optical waveguide and the reflective sheet.

However, in this case, light leakage from the space between the optical waveguide and the reflective sheet cannot be prevented by the technologies described in PTL 1 and PTL 2.

The light leakage from the space between the optical waveguide and the reflective sheet will now be briefly described with reference to FIG. 9. Referring to FIG. 9, a liquid crystal panel 900 includes an LED group 904 attached to an LED substrate 902 as a light source. Light is caused to propagate through an optical waveguide 930, and is emitted from a surface of the optical waveguide 930 that opposes a reflective sheet 910.

In this case, light that has entered the space between the optical waveguide 930 and the reflective sheet 910, as shown in region E in FIG. 9, is reflected by the reflective sheet 910, is incident on the optical waveguide 930, and is emitted from the surface of the optical waveguide 930 that opposes the reflective sheet 910 in a region near the LED group 904. This light leakage cannot be prevented by the technologies of the related art, and the brightness of the liquid crystal display cannot be made uniform.

The present invention has been made to solve the above-described problem, and its object is to provide a light source module with which light leakage can be efficiently reduced and an increase in costs can be suppressed.

### Solution to Problem

To achieve the above-described object, a light source module according to an embodiment of the present invention includes a light source; an optical waveguide that receives light emitted from the light source at a light receiving surface and emits the light received at the light receiving surface from an emission surface; a reflective sheet arranged so as to face a back surface of the optical waveguide, the back surface opposing the emission surface; and a fixing chassis that presses the optical waveguide from an emission-surface side and that is arranged so as to cover a portion of the emission surface near the light receiving surface. A center position of a light emitting surface of the light source is closer to the emission surface than a centerline of the light receiving surface.

With the above-described structure, the portion of the emission surface near the light receiving surface is covered by the fixing chassis. Therefore, with the light source module, light that leaks from the portion of the emission surface near the light receiving surface can be shielded by using the fixing chassis. Thus, the light source module requires no additional member for preventing light leakage, and an increase in costs can be suppressed.

In addition, by positioning the center position of the light source closer to the emission surface than the center position of the light receiving surface, an amount of light that enters the space between the optical waveguide and the reflective sheet can be reduced. Accordingly, with the light source module, light leakage from the space between the optical waveguide and the reflective sheet can be prevented. As a result, with the above-described light source module, the light leakage can be efficiently reduced and an increase in costs can be suppressed.

In the light source module according to the embodiment of the present invention, preferably, the reflective sheet is arranged so as to cover the back surface.

With this structure, the reflective sheet is arranged so as to extend to the ends of the back surface. Therefore, even when light is emitted from any portion of the back surface, the reflective sheet reflects the emitted light and causes the light to be incident on the optical waveguide again. Accordingly, with the light source module, the utilization ratio of the light emitted from the light source can be increased.

In the light source module according to the embodiment of the present invention, preferably, the fixing chassis has light absorbing characteristics.

With this structure, when a part of the light emitted from the light source reaches the fixing chassis instead of being incident on the optical waveguide, the light that has reached the fixing chassis is absorbed by the fixing chassis and is hardly reflected. Thus, the fixing chassis efficiently reduces the light leakage.

In addition, in the light source module according to the embodiment of the present invention, preferably, a length of the light emitting surface of the light source in a thickness direction of the optical waveguide is greater than half a thickness of the optical waveguide.

In general, light leakage becomes more conspicuous as the length of the light emitting surface of the light source in the thickness direction of the optical waveguide (hereinafter also referred to simply as length) relative to the thickness of the optical waveguide increases. This is because as the length of the light emitting surface of the light source relative to the thickness of the optical waveguide increases, the emission angle (angle of emitted light with respect to the direction perpendicular to the light emitting surface) at which the light emitted from portions of the light emitting surface near the emission surface and the back surface of the optical waveguide does not become lost light that is not incident on the light receiving surface decrease.

More specifically, even when light is emitted at a constant emission angle, the emitted light does not become lost light when the length of the light emitting surface of the light source relative to the thickness of the optical waveguide is small, and becomes lost light when the length of the light emitting surface of the light source relative to the thickness of the optical waveguide is large.

In the above-described light source module, even when the light emitted from the portions of the light emitting surface near the emission surface and the back surface of the optical waveguide becomes lost light, leakage of the lost light can be efficiently reduced.

Thus, even when the length of the light emitting surface of the light source is greater than half the thickness of the optical waveguide, a light source module with which light leakage is reduced and an increase in costs is suppressed can be realized. Accordingly, reduction in the light leakage and reduction in the thickness of the optical waveguide can both be achieved. As a result, the thickness of the light source module can be further reduced.

In the light source module according to the embodiment of the present invention, preferably, a plurality of light diffusing portions that diffuse light that propagates through the optical waveguide are formed on the back surface.

With this structure, the light diffusing portions diffuse the light that propagates through the optical waveguide, and change the travelling direction of the light. Accordingly, the light that propagates through the optical waveguide 130 can be emitted from the emission surface with uniform brightness.

An electronic apparatus, such as a liquid crystal display device, characterized by including the above-described light source module is also included in the scope of the present invention.

### Advantageous Effects of Invention

As described above, a light source module according to an embodiment of the present invention includes a light source; an optical waveguide that receives light emitted from the light source at a light receiving surface and emits the light received at the light receiving surface from an emission surface; a reflective sheet arranged so as to face a back surface of the optical waveguide, the back surface opposing the emission surface; and a fixing chassis that presses the optical waveguide from an emission-surface side and that is arranged so as to cover a portion of the emission surface near the light receiving surface. A center position of a light emitting surface of the light source is closer to the emission surface than a centerline of the light receiving surface.

With this structure, the light source module requires no additional member for preventing light leakage, and an increase in cost can be suppressed. In addition, with the light source module, the light leakage can be efficiently reduced by reducing the amount of light that leaks from the space between the optical waveguide and the reflective sheet.

### BRIEF DESCRIPTION OF DRAWINGS

FIG. 1 is a diagram illustrating the structure of a backlight module included in a liquid crystal display device according to an embodiment of the present invention.

FIG. 2 is an exploded perspective view illustrating the schematic structure of the liquid crystal display device according to the embodiment of the present invention.

FIG. 3 is a diagram illustrating the arrangement of an optical waveguide and LED substrates in the liquid crystal display device according to the embodiment of the present invention.

FIG. 4 is a diagram illustrating the structure of a backlight module to be compared with the backlight module included in the liquid crystal display device according to the embodiment of the present invention.

FIG. 5 is a diagram illustrating the evaluation results of the brightness at an end portion of a liquid crystal display panel according to the embodiment of the present invention.

FIG. 6 is a graph showing the brightness of the liquid crystal display panel versus distance from a light emitting surface of an LED group for each of the cases of (a) to (c) in FIG. 5.

FIG. 7 is a diagram illustrating an example of light diffusing portions formed on the back surface of the optical waveguide according to the embodiment of the present invention.

FIG. 8 is a diagram illustrating another example of light diffusing portions formed on the back surface of the optical waveguide according to the embodiment of the present invention.

FIG. 9 is an explanatory diagram illustrating the relationship between a space between an optical waveguide and a reflective sheet and light leakage according to the related art.

### DESCRIPTION OF EMBODIMENTS

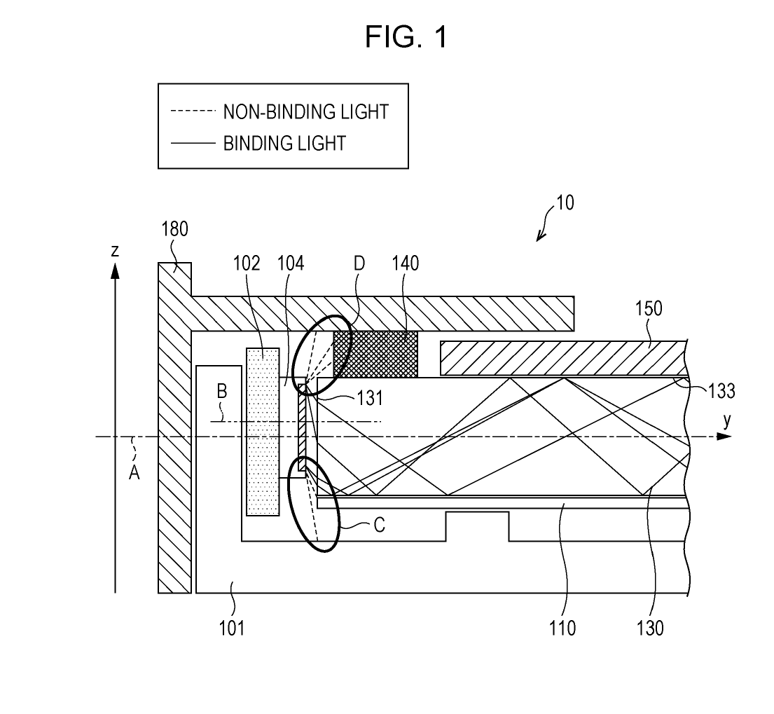

A light source module and an electronic apparatus including the light source module according to an embodiment of the present invention will now be described with reference to FIGS. 1 to 6. The structures described in this embodiment are merely examples, and are not intended to limit the scope of the present invention only to the described structures unless otherwise specified.

In this embodiment, a case in which the electronic apparatus is realized as a liquid crystal display device and the light source module is realized as a backlight module of the liquid crystal display device is described. However, the electronic apparatus and the light source module are not limited to this. For example, an indoor illuminating device is another example of the electronic apparatus, and a light-emitting portion of the illuminating device is another example of the light source module.

### [Liquid Crystal Display Device]

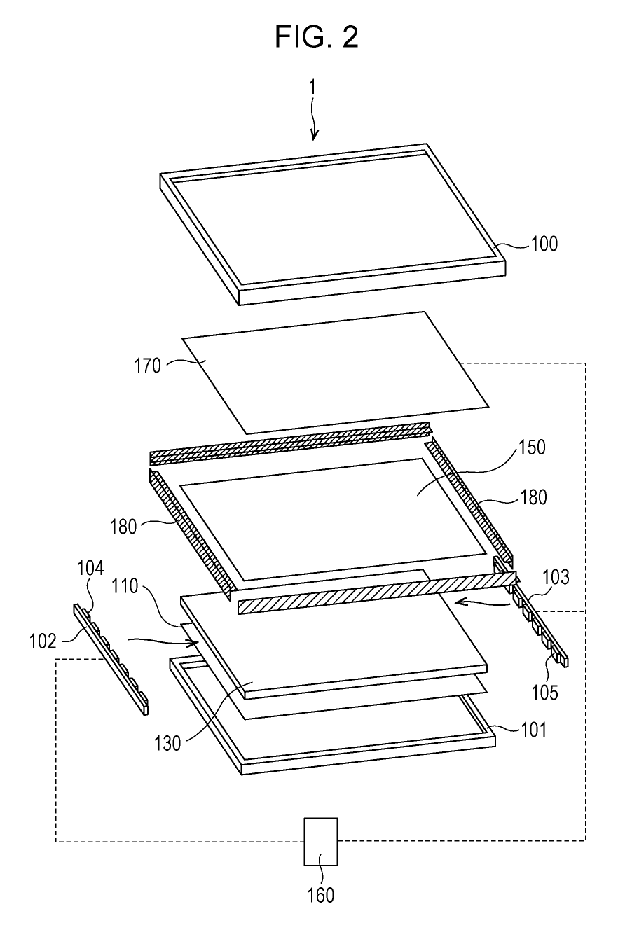

First, the schematic structure of the liquid crystal display device according to the present embodiment will be described with reference to FIG. 2. FIG. 2 is an exploded perspective view illustrating the schematic structure of a liquid crystal display device 1 according to the present embodiment.

As illustrated in FIG. 2, the liquid crystal display device 1 according to the first embodiment of the present invention includes a bezel 100, a chassis 101, LED substrates 102 and 103, LED groups (light sources) 104 and 105, a reflective sheet 110, an optical waveguide 130, a sheet stack 150, a controller 160, a liquid crystal display panel 170, and a fixing chassis, which is also called a P-chassis 180.

With regard to the arrangement of the above-described components of the liquid crystal display device 1, as illustrated in FIG. 2, the chassis 101, the reflective sheet 110, the optical waveguide 130, the sheet stack 150, and the liquid crystal display panel 170 are arranged in that order from the chassis-101 side. The LED substrate 102 provided with the LED group 104 and the LED substrate 103 provided with the LED group 105 are arranged so as to face respective side surfaces of the optical waveguide 130 in the longitudinal direction. The P-chassis 180 is arranged so as to cover the LED substrate 103 from above the sheet stack 150. The thickness direction of the optical waveguide 130 and the position of the bezel 100 are determined by the P-chassis 180. The LED substrates 102 and 103 and the liquid crystal display panel 170 are connected to the controller 160.

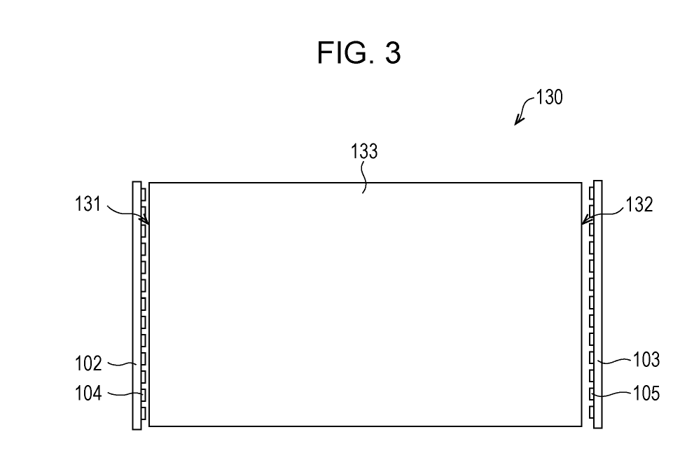

The arrangement of the optical waveguide 130 and the LED substrates 102 and 103 will now be described with reference to FIG. 3. FIG. 3 is a diagram illustrating the arrangement of the optical waveguide 130 and the LED substrates 102 and 103 in the liquid crystal display device 1 according to the present embodiment. FIG. 3 illustrates the optical waveguide 130 viewed from an emission-surface 133 side.

As illustrated in FIG. 3, the LED substrate 102 provided with the LED group 104 is arranged so as to face an incident surface (light receiving surface) 131, which is one of the side surfaces of the optical waveguide 130 in the longitudinal direction. The LED substrate 103 provided with the LED group 105 is arranged so as to face an incident surface (light receiving surface) 132, which is the other of the side surfaces of the optical waveguide 130 in the longitudinal direction.

### (Bezel)

The bezel 100 is a housing member that protects the liquid crystal display device 1, and is arranged so as to cover the liquid crystal display device 1 (that is, so as to cover the liquid crystal display panel 170) from an image-displaying side, as illustrated in FIG. 2. The bezel 100 has a window portion so that the display area of the liquid crystal display panel 170 can be viewed.

### (Chassis)

The chassis 101 is also a housing member that protects the liquid crystal display device 1, and is arranged so as to cover the liquid crystal display device 1 from the side opposite to the image-displaying side, as illustrated in FIG. 2.

The bezel 100 and the chassis 101 are fixed to each other with fixing members (not shown) so as to clamp the components of the liquid crystal display device 1 disposed between the bezel 100 and the chassis 101. Accordingly, parts of end portions of the optical waveguide 130 are clamped between the P-chassis 180 and the reflective sheet 110 so that the position of the optical waveguide 130 with respect to the LED substrates 102 and 103 in the thickness direction (that is, the position of the optical waveguide 130 with respect to the LED groups 104 and 105 in the thickness direction) is determined.

### (LED Groups and LED Substrates)

The LED substrate 102 is provided with the LED group 104 including a plurality of LEDs, and the LED substrate 103 is provided with the LED group 105 including a plurality of LEDs. The LEDs included in the LED groups 104 and 105 are arranged on the LED substrates 102 and 103, respectively, with intervals therebetween. The LED substrates 102 and 103 are respectively arranged so as to face the incident surfaces 131 and 132 of the optical waveguide 130.

Light emitted from the LED group 104 of the LED substrate 102 is incident on the incident surface 131 of the optical waveguide 130, and light emitted from the LED group 105 of the LED substrate 103 is incident on the incident surface 132 of the optical waveguide 130.

In the present embodiment, a case in which the LEDs are used as light sources is described. However, the present invention is not limited to this, and light sources other than LEDs, such as fluorescent tubes, may instead be used as light sources.

### (Optical Waveguide)

As illustrated in FIG. 3, the optical waveguide 130 has the incident surfaces 131 and 132, and receives the light emitted from the LED group 104 provided on the LED substrate 102, which is arranged so as to face the incident surface 131, at the incident surface 131. Also, the optical waveguide 130 receives the light emitted from the LED group 105 provided on the LED substrate 103, which is arranged so as to face the incident surface 132, at the incident surface 132.

The optical waveguide 130 also has an emission surface 133. Light diffusing portions are formed on a back surface of the optical waveguide 130 that opposes the emission surface 133. The light diffusing portions diffuse the incident light to change the travelling direction of the light in the optical waveguide 130.

The optical waveguide 130 propagates the light incident on the incident surfaces 131 and 132 toward the inner region thereof while totally reflecting the light between the emission surface 133 and the back surface and between the side surfaces thereof in the short-side direction, and emits the light from the emission surface 120.

In addition, as described above, the light diffusing portions are arranged with intervals therebetween on the back surface of the optical waveguide 130.

The light diffusing portions are formed by, for example, dispersing light scattering particles into a polymer, and then printing the polymer onto the back surface of the optical waveguide 130. The light scattering particles may be, for example, particles of a fluorescent material. However, the light scattering particles are not limited to this.

In the present embodiment, a method of printing the polymer onto the back surface of the optical waveguide 130 is described as an example of a method for forming the light diffusing portions. However, the present invention is not limited to this. For example, the light diffusing portions may instead be formed by forming small protrusions and recesses, such as prisms, on the back surface of the optical waveguide 130. Alternatively, the light diffusing portions may be formed by performing laser processing, blasting, etc., on the back surface of the optical waveguide 130.

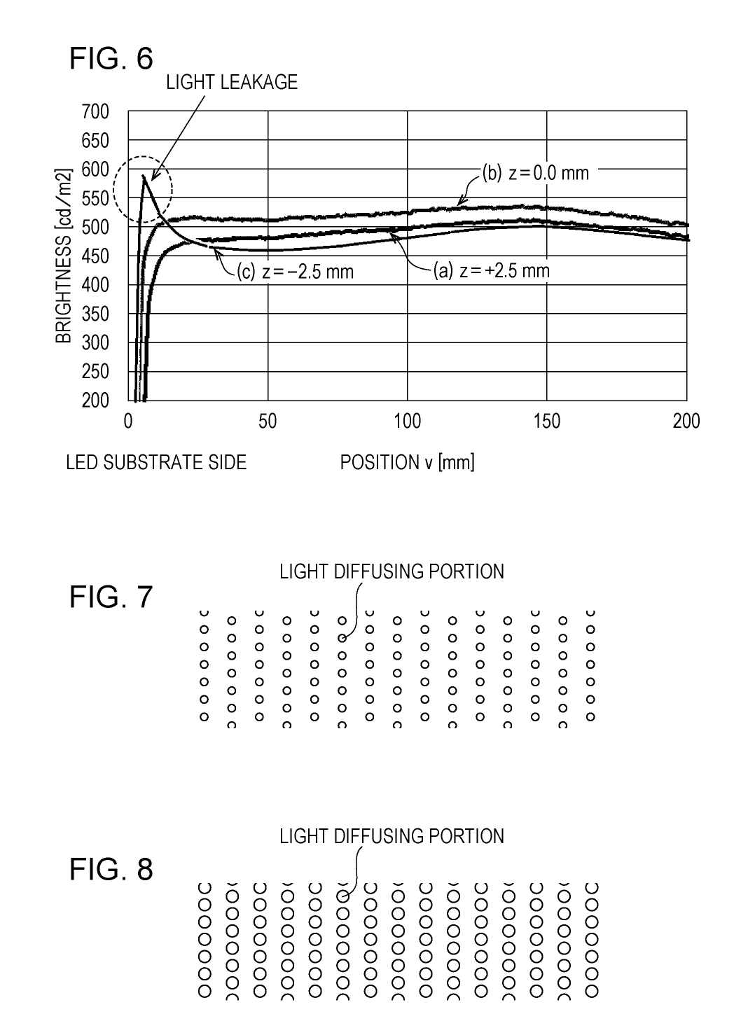

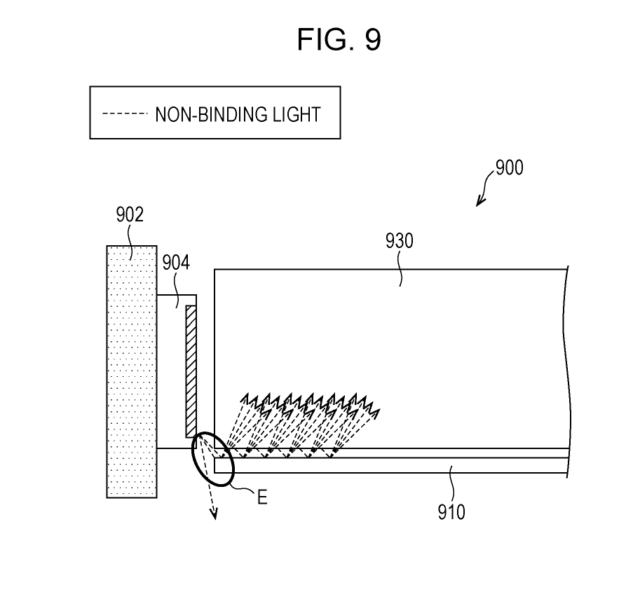

The light diffusing portions may be, for example, dot-shaped as illustrated in FIGS. 7 and 8. FIGS. 7 and 8 are diagrams illustrating examples of the light diffusing portions formed on the back surface of the optical waveguide 130 according to the present embodiment. FIG. 7 illustrates the back surface of the optical waveguide 130 on which light diffusing portions having a small dot diameter are formed, and FIG. 8 illustrates the back surface of the optical waveguide 130 on which light diffusing portions having a large dot diameter are formed.

The light diffusing portions are formed such that the dot diameter thereof increases from the incident surface 131 toward the central region of the optical waveguide 130 in the longitudinal direction. Similarly, the light diffusing portions are formed such that the dot diameter thereof increases from the incident surface 132 toward the central region of the optical waveguide 130 in the longitudinal direction. For example, the light diffusing portions may be formed on the back surface of the optical waveguide 130 such that the dot diameter thereof increases from the incident surfaces 131 and 132, where the dot diameter is small as illustrated in FIG. 7, toward the central region of the optical waveguide 130 in the longitudinal direction, where the dot diameter is large as illustrated in FIG. 8.

The light diffusing portions are arranged so as to be symmetrical with respect to an imaginary axial line that extends in the longitudinal direction of the optical waveguide 130 through the center of the optical waveguide 130 in the short-side direction.

The dot diameter of the light diffusing portions is preferably in the range of, for example, 0.3 mm or more and 1.5 mm or less. Although an example in which the light diffusing portions are dot-shaped has been described, the shape of the light diffusing portions is not limited to this, and may instead be, for example, a linear shape, an elliptical shape, or a rectangular shape. More specifically, the light diffusing portions are not limited as long as they have a light diffusing function and the amount of diffused light can be adjusted by the size (length) thereof.

When the light diffusing portions are formed on the back surface of the optical waveguide 130 as described above, the optical path of the light that propagates through the optical waveguide 130 can be changed. More specifically, when the light that propagates through the optical waveguide 130 is incident on the light diffusing portions formed on the back surface of the optical waveguide 130, the light diffusing portions diffuse the incident light and change the travelling direction of the light in the optical waveguide 130. As a result, at least a part of the light diffused by the light diffusing portions is emitted from the emission surface 133 to the outside instead of being totally reflected by the emission surface 133. Accordingly, the optical waveguide 130 is capable of emitting light having a uniform brightness from the emission surface 133.

The light that has entered the optical waveguide 130 through the incident surfaces 131 and 132 is diffused and the amount thereof decreases as the light travels away from the incident surfaces 131 and 132. As described above, by increasing the area (dot diameter in the present embodiment) of the light diffusing portions from the incident surfaces 131 and 132 toward the central region in the longitudinal direction, the arrangement density of the light diffusing portions can be increased as the distances from the incident surfaces 131 and 132 increase. With this structure, the amount of light diffused in the optical waveguide 130 can be increased as the distances from the light receiving surfaces increase. Consequently, uniformity of the amount of light emitted from the emission surface 120, that is, uniformity of brightness of the liquid crystal display panel 170, can be efficiently improved.

The optical waveguide 130 is made of a transparent material having a high transparency. For example, PMMA (acrylic), PC (polycarbonate), or PS (polystyrene) is preferably used.

In the present embodiment, a case in which light is incident on both end surfaces (incident surfaces 131 and 132) of the optical waveguide 130 in the longitudinal direction is described. However, the present invention is not limited to this. For example, the configuration may instead be such that light is incident on only one of the end surfaces, or on one or both of end surfaces in the short-side direction.

In the case where, for example, light is incident on the end surfaces of the optical waveguide 130 in the short-side direction in addition to the end surfaces of the optical waveguide 130 in the longitudinal direction, the uniformity of brightness can be improved by forming the light diffusing portions such that the area of the light diffusing portions increases from the four end surfaces toward the center of the optical waveguide 130.

### (Reflective Sheet)

The reflective sheet 110 is arranged so as to face a surface of the optical waveguide 130 that opposes the emission surface 133. The reflective sheet 110 reflects the light emitted from the surface that opposes the emission surface 133 so that the reflected light is incident on the optical waveguide again. The reflective sheet 110 also has a function of reflecting the light diffused by the light diffusing portions of the optical waveguide 130 and causing the reflected light to be emitted from the emission surface 133.

Although it is not necessary that the reflective sheet 110 be provided, when the reflective sheet 110 is used, light that is otherwise absorbed at the chassis-101 side can be effectively utilized. Therefore, the amount of light emitted from the emission surface 120 can be increased. Thus, the reflective sheet 110 is capable of increasing the brightness of the liquid crystal display panel 170.

The reflective sheet 110 is made of, for example, polyester, such as foamed polyethylene terephthalate (PET), and has light reflecting characteristics. The reflective sheet 110 has a function of reflecting light that has leaked from the back surface of the optical waveguide 130 and causes the reflected light to pass through the optical waveguide 130 toward the liquid crystal panel.

The reflective sheet 110 may be a sheet that causes regular reflection of the incident light. However, a sheet that causes diffused reflection of the incident light is preferably used. In the case where the reflective sheet 110 is a sheet that causes diffused reflection of the incident light, the incident light can be reflected such that the reflected light includes a component at an angle different from the incident angle.

### (Sheet Stack)

The sheet stack 150 has a function of improving the uniformity of the amount of light emitted from the optical waveguide 130 (that is, uniformity of brightness) and a function of collecting the light from the optical waveguide 130 and emitting the light toward the liquid crystal display panel 170.

The sheet stack 150 includes, for example, a diffusing sheet, a prism sheet, and a microlens sheet. The number and combination of the sheets included in the sheet stack 150 are not particularly limited as long as the desired optical performance can be provided.

### (Controller)

The controller 160 is means for performing an overall control of each component of the liquid crystal display device 1. The controller 160 switches the on/off state of each TFT element (not shown) included in the liquid crystal display panel 170 in accordance with the display timing of an image represented by an image signal. The controller 160 also applies the image signal to the liquid crystal display panel 170 and causes the liquid crystal display panel 170 to display the image represented by the image signal.

In the case where a plurality of optical waveguides 130 are provided, the controller 160 may successively turn off the LEDs included in the LED groups 104 and 105 in synchronization with the timing for applying the image signal. Thus, the controller 160 is capable of setting a period in which light is emitted from the emission surface 133 of one of the optical waveguides 130 (illuminating period) and a period in which light is not emitted (non-illuminating period) in a single frame. Therefore, an image display and a black display can be alternately presented on the liquid crystal display panel 170.

### (Liquid Crystal Display Panel)

The liquid crystal display panel 170 includes an active matrix substrate, a color filter, a counter substrate, and liquid crystal confined between the active matrix substrate and the counter substrate (none of which are shown). A plurality of thin film transistor (TFT) elements are formed on the active matrix substrate. The liquid crystal display panel 170 displays an image by using light incident on the liquid crystal display panel 170 through the sheet stack 150.

The positional relationship between the LED substrate 102 and the incident surface 131 of the optical waveguide 130 in the thickness direction is adjusted by the above-described chassis 101. The optical waveguide 130 is fixed to the chassis 101 with a connecting member (not shown), so that the clearance between the optical waveguide 130 and the LED substrate 102 is maintained constant.

### (P-Chassis)

The P-chassis 180 will now be described with reference to FIG. 1. FIG. 1 is a diagram illustrating the structure of a backlight module 10 included in the liquid crystal display device 1 according to the present embodiment. In FIG. 1, only a portion of the backlight module 10 according to the present embodiment (a portion of the backlight module 10 in which the LED group 104 is disposed) is illustrated. However, a portion that is not illustrated (a portion of the backlight module 10 in which the LED group 105 is disposed) has a similar structure.

As illustrated in FIG. 1, the backlight module 10 according to the present embodiment includes the LED substrates 102 and 103, the LED groups 104 and 105, the reflective sheet 110, the optical waveguide 130, the sheet stack 150, and the P-chassis 180.

As illustrated in FIG. 1, the LED group 104 of the LED substrate 102 is provided on the chassis 101. In addition, the LED group 104 is arranged so as to face the incident surface 131 of the optical waveguide 130.

The P-chassis 180 is arranged so as to cover the LED substrates 102 and 103 and portions of the optical waveguide 130 including the incident surfaces 131 and 132. The P-chassis 180 secures the optical waveguide 130 so that the optical waveguide 130 is prevented from being raised toward the P-chassis-180 side (that is, toward the liquid crystal display panel 170).

The P-chassis 180 has light shielding characteristics, and prevents light leakage from the portions of the optical waveguide 130 covered by the P-chassis 180. In other words, the P-chassis 180 has a securing function for securing the optical waveguide 130, and a light shielding function for prevented light leakage. Therefore, when the P-chassis 180 is used, no additional member for preventing light leakage needs to be used, and an increase in costs can be suppressed.

The bezel 100 (not shown in FIG. 1) is arranged so as to cover the P-chassis 180 from the liquid-crystal-display-panel-170 side. End portions of the liquid crystal display panel 170 are clamped between the P-chassis 180 and the bezel 100 with cushioning members (not shown) interposed therebetween.

As in the backlight module 10 illustrated in FIG. 1, in the present embodiment, the P-chassis 180, which has light shielding characteristics, is provided so as to cover the light emitting surface of the LED group 104 and a portion of the emission surface 133 that is near the incident surface 131 from the emission-surface-133 side. Also, the chassis 101 is provided to cover them from the side opposite to the emission-surface-133 side. Thus, in the backlight module according to the present embodiment, light that is not incident on the optical waveguide 130 can be prevented from leaking from the emission-surface-133 side.

The reflective sheet 110 is formed so as to cover a surface (back surface) of the optical waveguide 130 that opposes the emission surface 133.

The material of the P-chassis 180 may be, for example, a polycarbonate resin that has light absorbing characteristics. However, the material is not particularly limited as long as light absorbing characteristics are provided. The material of the P-chassis 180 preferably has a predetermined strength. The P-chassis 180 may be manufactured by, for example, molding. However, the manufacturing method of the P-chassis 180 is not limited to this.

### [Backlight Module]

Next, reduction of light leakage in the light source module included in the liquid crystal display device 1 according to the present embodiment will be described with reference to FIG. 1. In FIG. 1, the y axis represents the longitudinal direction of the optical waveguide 130, and the z axis represents the thickness direction of the optical waveguide 130.

In FIG. 1, the centerline A shows the center of the thickness (distance from the emission surface 133 to the back surface) of the optical waveguide 130, and the centerline B shows the center of the light emitting surface of the LED group 104. In FIG. 1, examples of light rays that are emitted from the LED group 104 and are incident on the optical waveguide 130 are shown by solid lines (“binding light” in FIG. 1), and light rays that are not incident on the optical waveguide 130 (lost light) are shown by broken lines (“non-binding light” in FIG. 1).

Referring to FIG. 1, the optical waveguide 130 is fixed to the P-chassis 180 with Poron 140 interposed therebetween. The Poron 140 has shock absorbing characteristics (cushioning characteristics), and the material of the Poron 140 may be, for example, urethane foam. Thus, the Poron 140 prevents the optical waveguide 130 from being damaged by the P-chassis 180. The Poron 140 may also have vibration isolation characteristics.

Furthermore, the Poron 140 preferably has sliding characteristics. In this case, the Poron 140 does not interfere with expansion and contraction of the optical waveguide 130, which has thermal expansion and contraction characteristics. In the case where the Poron 140 has frictional resistance, the optical waveguide 130 can be effectively fixed to the P-chassis 180 with the Poron 140 provided therebetween.

The sliding characteristics and frictional resistance of the Poron 140 can be obtained by combining PET, rubber, etc., with the above-described material having cushioning characteristics, such as urethane foam. The sliding characteristics and frictional resistance of the Poron 140 can also be obtained by forming a special coating on the surface of the Poron 140.

In the present embodiment, an example in which the optical waveguide 130 included in the backlight module 10 is composed of a single optical waveguide having a rectangular parallelepiped shape is described. However, the present invention is not limited to this. For example, the optical waveguide 130 may have a shape other than the rectangular parallelepiped shape or include a plurality of optical waveguides that are separated from each other.

As illustrated in FIG. 1, in the backlight module 10 according to the present embodiment, the centerline A of the optical waveguide 130 is on the chassis-101 side of the centerline B of the LED group 104. In other words, the position of the LED group 104 with respect to the optical waveguide 130 is shifted toward the emission surface 133 of the optical waveguide 130.

In this case, the amount of lost light in the light emitted from a portion of the light emitting surface of the LED group 104 near the emission surface 133 (lost light D in FIG. 1) is larger than the amount of lost light in the light emitted from a portion the light emitting surface of the LED group 104 near the back surface of the optical waveguide 130 (lost light C in FIG. 1).

This is because the light emitted from the portion of the light emitting surface of the LED group 104 near the emission surface 133 cannot be incident on the optical waveguide 130 and becomes lost light even when the emission angle thereof (angle of the emitted light with respect to the direction perpendicular to the light emitting surface) is relatively small, whereas the light emitted from the portion of the light emitting surface of the LED group 104 near the back surface of the optical waveguide 130 is incident on the optical waveguide 130 even when the emission angle thereof is relatively large.

As illustrated in FIG. 1, the lost light D is absorbed by the P-chassis 180, which has light absorbing characteristics, and the Poron 140. Most of the lost light C is absorbed by the chassis 101. Thus, the lost light C and the lost light D are absorbed before leaking toward the liquid crystal display panel 170. As a result, the light leakage can be reduced.

A part of the lost light C enters the space between the optical waveguide 130 and the reflective sheet 110. However, since the amount of lost light C is small, the amount of the part of the lost light C that enters the space between the optical waveguide 130 and the reflective sheet 110 is extremely small, and light leakage due to the light that enters this space can be greatly reduced.

Thus, with the backlight module 10 according to the present embodiment, the light leakage can be efficiently reduced without using an additional member. In addition, a user can enjoy the image displayed by the liquid crystal display device 1 without noticing the light leakage due to the light that has entered the space between the optical waveguide 130 and the reflective sheet 110.

In general, light leakage becomes more conspicuous as the length of the light emitting surface of the LED group 104 in the thickness direction of the optical waveguide 130 (hereinafter also referred to simply as length) relative to the thickness of the optical waveguide 130 increases. This is because as the length of the light emitting surface of the LED group 104 relative to the thickness of the optical waveguide 130 increases, the emission angle at which the light emitted from the portion of the light emitting surface near the emission surface 133 or the back surface of the optical waveguide 130 does not become lost light decreases.

More specifically, even when light is emitted at a constant emission angle, the emitted light does not become lost light when the length of the light emitting surface of the LED group 104 relative to the thickness of the optical waveguide 130 is small, and becomes lost light when the length of the light emitting surface of the LED group 104 relative to the thickness of the optical waveguide 130 is large.

In the backlight module 10 according to the present embodiment, owing to the above-described structure, even when the light emitted from the portions of the light emitting surface near the emission surface 133 and the back surface of the optical waveguide 130 becomes lost light, leakage of the lost light can be efficiently reduced.

Thus, according to the present embodiment, even when the length of the light emitting surface of the LED group 104 is greater than half the thickness of the optical waveguide 130, the backlight module 10 with which the light leakage is reduced and an increase in costs is suppressed can be realized. In other words, the backlight module 10 including the optical waveguide 130 whose thickness is smaller than twice the length of the light emitting surface of the LED group 104 can be realized.

The length of the light emitting surface of the LED group 104 is preferably smaller than or equal to the thickness of the optical waveguide 130. In this case, the LED group 104 can be arranged so that the portion of the light emitting surface of the LED group 104 near the back surface of the optical waveguide 130 does not protrude from the back surface of the optical waveguide 130 toward the reflective-sheet-110 side.

Accordingly, the amount of lost light that enters the space between the optical waveguide 130 and the reflective sheet 110 can be reduced, and the light leakage due to the light that has entered the space can be reduced.

Thus, according to the present embodiment, reduction in the light leakage and reduction in the thickness of the optical waveguide 130 can both be achieved. As a result, the thickness of the backlight module 10 can be further reduced.

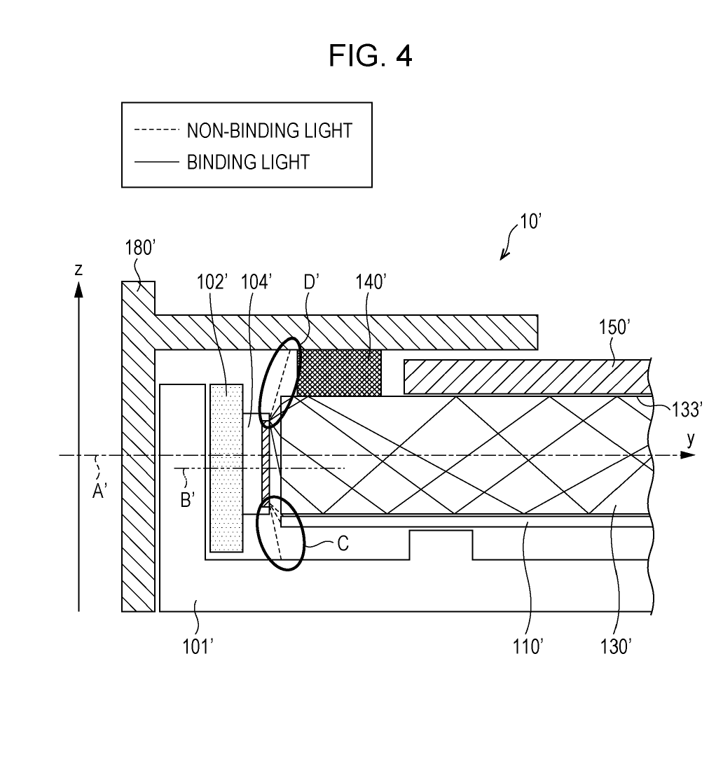

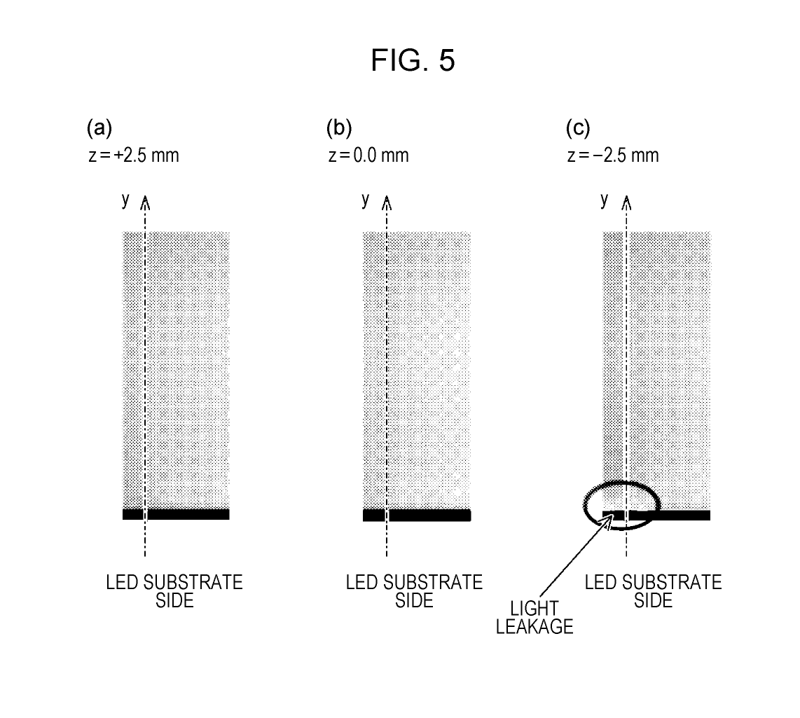

Here, as a backlight module to be compared with the backlight module 10 according to the present embodiment, a backlight module 10′ in which a centerline A′ of an optical waveguide 130′ is on a liquid-crystal-display-panel side (sheet-stack-150′ side) of a centerline B′ of a LED group 104′ will be described with reference to FIG. 4. FIG. 5 is a diagram illustrating the structure of the backlight module 10′ to be compared with the backlight module 10 according to the present embodiment.

In the backlight module 10′ illustrated in FIG. 4, the position of the LED group 104′ relative to the optical waveguide 130′ is shifted toward a chassis-101′ side.

In this case, the amount of lost light in the light emitted from a portion of the light emitting surface of the LED group 104′ near a back surface of the optical waveguide 130′ (lost light C′ in FIG. 4) is larger than the amount of lost light in the light emitted from a portion of the light emitting surface of the LED group 104′ near an emission surface 133′ (lost light D′ in FIG. 4).

This is because the light emitted from the portion of the light emitting surface of the LED group 104′ near the back surface of the optical waveguide 130′ cannot be incident on the optical waveguide 130′ and becomes lost light even when the emission angle thereof is relatively small, whereas the light emitted from the portion of the light emitting surface of the LED group 104′ near the emission surface 133′ is incident on the optical waveguide 130′ even when the emission angle thereof is relatively large.

As illustrated in FIG. 4, the lost light D′ is absorbed by a P-chassis 180′, which has light absorbing characteristics, and Poron 140′. Most of the lost light C′ is absorbed by a chassis 101′.

A part of the lost light C′ enters the space between the optical waveguide 130′ and the reflective sheet 110′. Since the amount of lost light C′ is large, when a part of the lost light C′ enters the space between the optical waveguide 130′ and the reflective sheet 110′, light reflected by the reflective sheet 110′ passes through the optical waveguide 130′ and is emitted toward the liquid crystal display panel 170′. As a result, a large amount of light leaks from the liquid crystal display panel 170′, and the light leakage becomes visually noticeable.

Consequently, the user cannot enjoy the image displayed by the liquid crystal display device 1 without noticing the light leakage.

### (Experiment Results)

Next, experimental results of evaluation of light leakage in the case where the relative position between the optical waveguide 130 and the LED group 104 in the z-axis direction is changed will be described with reference to FIGS. 5 and 6.

FIG. 5 illustrates the result of evaluation of brightness of the liquid crystal display panel 170 in a region near an end portion of the backlight module 10 according to the present embodiment in which the LED group 104 is disposed. FIG. 5(a) shows the result of evaluation of the brightness in the case where the center of the LED substrate 102 is closer to the emission surface 133 than the center of the optical waveguide 130. FIG. 5(b) shows the result of evaluation of the brightness in the case where the center of the LED group 104 and the center of the optical waveguide 130 are at the same position. FIG. 5(c) shows the result of evaluation of the brightness in the case where the center of the LED group 104 is closer to the back surface of the optical waveguide 130 than the center of the optical waveguide 130.

FIG. 6 is a graph showing the brightness of the liquid crystal display device 1 versus distance from the LED group 104 (distance in the y-axis direction when the light emitting surface of the LED group 104 is at the origin) in each of the cases of FIGS. 5(a) to 5(c).

For the brightness evaluation of FIGS. 5 and 6, LEDs with a height in the z-axis direction of 3.0 mm and an optical waveguide with a height in the z-axis direction of 3.5 mm were used. The center position of the light emitting surface of the LED group 104 was defined as z=0 mm, and a displacement of the center position of the optical waveguide from this position toward the emission-surface-133 side was defined as a displacement in a positive (+) direction, and that toward the chassis-101 side was defined as a displacement in a negative (−) direction. The state in which the center of the light emitting surface of the LED group 104 and the center of the optical waveguide 130 are at the same position was defined as the state in which no displacement is provided, that is, the displacement is 0 mm.

In the present embodiment, the brightness was evaluated for the cases in which the center of the LED group 104 was displaced from the center of the optical waveguide 130 by (a)+0.25 mm, (b) 0 mm, and (c) −0.25 mm.

As is clear from FIG. 5(a), when the center of the LED group 104 was displaced from the center of the optical waveguide 130 by +0.25 mm in the z-axis direction, light leakage hardly occurred and degradation in brightness uniformity due to light leakage was suppressed.

As is clear from FIG. 5(b), when the center of the LED group 104 and the center of the optical waveguide 130 were at the same position (when the displacement was 0 mm), the amount of light leakage was larger than that in the case of FIG. 5(a). However, the light leakage and degradation in brightness uniformity were somewhat suppressed.

As is clear from FIG. 5(c), when the center of the LED group 104 was displaced from the center of the optical waveguide 130 by −0.25 mm in the z-axis direction, a large amount of light leaked in a region near the LED substrate 102, and brightness uniformity was largely degraded due to the light leakage.

Referring to FIG. 6, in the cases of (a) and (b) in FIG. 5, the brightness of the optical waveguide 130 was substantially uniform. In contrast, in the case of (c), the brightness of the optical waveguide 130 was high in the range of y=0 mm to y=25 mm. Thus, it is clear that light leakage occurred.

Accordingly, in the backlight module 10 of the present embodiment, the P-chassis 180 is arranged so as to secure the optical waveguide 130 and cover the portions of the optical waveguide 130 including the incident surfaces 131 and 132, and the center of the LED group 104 is shifted from the center of the optical waveguide 130 toward the positive side in the z-axis direction. As a result, the light leakage can be efficiently reduced without using an additional member.

Although an embodiment of the present invention has been described above, the present invention is not limited to the above-described embodiment, and various modifications are possible within the scope of the claims. In other words, an embodiment obtained by appropriately combining technical means modified within the scope of the claims is also included in the technical scope of the present invention. The technical scope of the present invention also includes meanings equivalent to the scope of the claims and all modifications within the scope.

### INDUSTRIAL APPLICABILITY

A light source unit according to an embodiment of the present invention is suitable for application to a light source module and an electronic apparatus including the light source module. The light source module is, for example, a backlight including a light source unit that emits light from a light source in linear form and an optical waveguide from which the light is emitted in planar form. The electronic apparatus is typically a liquid crystal display device, such as a television receiver or a monitor. The light source module is suitable for application to an electronic apparatus such as an illuminating apparatus that functions as a large planar light source.

### Reference Signs List

1 liquid crystal display device (electronic apparatus)

10 backlight module (light source module)

100 bezel

101 chassis

102, 103 LED substrate

104, 105 LED group (light source)

110 reflective sheet

130 optical waveguide

131, 132 incident surface (light receiving surface)

133 emission surface

140 Poron

150 sheet stack

160 controller

170 liquid crystal display panel

180 P-chassis (fixing chassis)

1. A light source module comprising:
a light source;
an optical waveguide that receives light emitted from the light source at a light receiving surface and emits the light received at the light receiving surface from an emission surface;
a reflective sheet arranged so as to face a back surface of the optical waveguide, the back surface opposing the emission surface; and
a fixing chassis that presses the optical waveguide from an emission-surface side and that is arranged so as to cover a portion of the emission surface near the light receiving surface,
wherein a center position of a light emitting surface of the light source is closer to the emission surface than a centerline of the light receiving surface.

2. The light source module according to claim 1, wherein the reflective sheet is arranged so as to cover the back surface.

3. The light source module according to claim 1, wherein the fixing chassis has light absorbing characteristics.

4. The light source module according to claim 1, wherein a length of the light emitting surface of the light source in a thickness direction of the optical waveguide is greater than half a thickness of the optical waveguide.

5. A liquid crystal display device comprising:
the light source module according to claim 1.
